(19) United States
(12) Patent Application Publication
(10) Pub. No.: US 2025/0368574 A1
(43) Pub. Date: Dec. 4, 2025

(54) USE OF FIBERS OF A POLYESTER-RESIN COMPOSITE FOR REINFORCING CONCRETE

(71) Applicant: COMPAGNIE GENERALE DES ETABLISSEMENTS MICHELIN, Clermont-Ferrand (FR)

(72) Inventors: KEVIN ROOS, Clermont-Ferrand (FR); PIERRE PLOUZENNEC, Clermont-Ferrand (FR); FABIEN PESQUET, Clermont-Ferrand (FR); SEBASTIEN RIGO, Clermont-Ferrand (FR)

(21) Appl. No.: 18/874,162

(22) PCT Filed: Jun. 14, 2023
(86) PCT No.: PCT/EP2023/065968

§ 371 Date: Dec. 12, 2024

(30) Foreign Application Priority Data
Jun. 15, 2022 (FR) 2205820

(51) Int. Cl. C04B 20/00; C04B 16/06; D01F 6/62

(52) U.S. Cl. CPC C04B 20/0068; C04B 16/0683; D01F 6/62; D10B 2401/063; D10B 2505/02

(57) ABSTRACT

A polyester-resin composite monofilament comprises polyester filaments embedded in a crosslinked resin, the monofilament having a length within a range from 5 to 85 mm, a diameter ranging from 0.2 to 1.3 mm, and a porosity of less than 2%. A concrete comprises these monofilaments as reinforcement, and a process for obtaining these monofilaments is disclosed.

The present invention relates to polyester-resin composite fibres for reinforcing concrete and to a process for obtaining same.

Concrete is arguably the most widely used building material today due to its high compressive strength, durability, longevity and resilience. Its properties make it a material of choice, particularly in the fields of building, roads and engineering structures.

Concrete is mainly composed of aggregates held together by a binder, most often Portland cement. To improve the properties of concrete, it is known practice to use additives such as ultrafine particles (silica fume for example), superplasticizers also called water reducing plasticizers, or metal, synthetic or mineral fibres.

Although very resistant to compression, concrete has a low tensile strength, tension often being accompanied by the appearance of cracks. To combat this problem, it is known practice to use reinforcing fibres. Due to their mechanical properties, metal fibres are particularly advantageous for reinforcing concrete. They are thus very widely used to make concrete more ductile and improve its resistance to cracking.

However, metal fibres have the disadvantage of being sensitive to corrosion, which can be detrimental to the longevity of concrete comprising such fibres. Furthermore, they often have densities greater than 7.7 and are therefore not distributed evenly in concrete with a lower density (metal fibres tend to sink under the effect of gravity, or even under the effect of vibration when the concrete is vibrated to get rid of any air bubbles that may have formed during pouring).

To solve this problem it has been proposed to replace the metal fibres with synthetic fibres. However, the mechanical strength (elastic (Young's) modulus, tensile strength, for example) of these fibres is not as good as that of metal fibres. Furthermore, their temperature of use (between 100° C. and 160° C., generally) is much lower than that of metal fibres (between 600° C. and 900° C. approximately), and this may limit their use for certain applications.

Thus, it remains advantageous to have fibres which are both resistant to corrosion, in order to improve the service life of the concrete, and which have improved mechanical properties compared to current non-metallic fibres, in order to improve the resistance to cracking.

In pursuing its research, the Applicant has unexpectedly discovered that the use of specific polyester-resin composite fibres makes it possible to solve the aforementioned problem.

The Applicant has also observed numerous advantages procured by the fibres according to the invention. They are very easy to implement compared to the fibres for concrete of the prior art, in particular during the phase of mixing the various components of the concrete (easily dispersible), but also during the phase of drying of the concrete: because their density is close to that of concrete, the fibres remain evenly distributed in the concrete (they do not tend to sink like metal fibres that are denser than concrete, nor to rise like synthetic fibres that are less dense than concrete). The fibres of the invention also have a much higher maximum temperature of use than the synthetic fibres currently used. In addition, more generally, because of their density and their capacity for reinforcement, the use of the fibres according to the invention makes it possible to greatly reduce the overall emissions of CO₂ compared to the use of other fibres of the prior art, for the same level of reinforcement.

Thus, the invention relates to a polyester-resin composite monofilament comprising polyester filaments embedded in a crosslinked resin, having a length within a range from 5 to 85 mm and a diameter ranging from 0.2 to 1.3 mm, and characterized in that the monofilament has a porosity of less than 2%.

It also relates to the use of at least one monofilament according to the invention to reinforce concrete and/or reduce the weight of concrete and/or reduce or prevent cracking of concrete, as well as a concrete comprising a plurality of monofilaments cut according to the invention, the volume ratio of the monofilaments in the concrete preferably being within a range from 0.1% to 6%.

The present invention also relates to a process for manufacturing a polyester-resin composite monofilament comprising polyester filaments embedded in a crosslinked resin, comprising the following successive steps:
creating a rectilinear arrangement of polyester filaments and conveying this arrangement in a feed direction,
in a vacuum chamber, degassing the arrangement of polyester filaments by the action of the vacuum,
at the outlet of the vacuum chamber, after degassing, passing through an impregnation chamber under vacuum so as to impregnate said arrangement of polyester filaments with a photocurable resin composition, in the liquid state, referred to as the “impregnation resin”, so as to obtain a prepreg containing the polyester filaments and the resin composition,
passing said prepreg through a sizing die having a cross section of predefined area and shape, to give it the shape of a monofilament,
downstream of the die, in a UV irradiation chamber, polymerizing the resin composition under the action of UV rays, the irradiation chamber comprising a tube transparent to UV rays, referred to as an irradiation tube, through which the monofilament being formed travels, and through which a stream of inert gas passes, the run speed (denoted Vᵢᵣ) of the monofilament through the irradiation chamber being greater than 50 m/min, the irradiation time (denoted Dᵢᵣ) of the monofilament in the irradiation chamber being equal to or greater than 1.5 s,
cutting the monofilament to a length within a range from 5 to 85 mm.

### I-DEFINITIONS

In the present document, unless expressly indicated otherwise, all the percentages (%) indicated are percentages (%) by weight.

The expression “composition based on” should be understood as meaning a composition including the mixture and/or the product of the in situ reaction of the various constituents used, some of these constituents being able to react and/or being intended to react with each other, at least partially, during the various phases of manufacture of the composition; it thus being possible for the composition to be in the completely or partially crosslinked state or in the non-crosslinked state.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

All the values for glass transition temperature “Tg” described in the present document are measured in a known manner by DSC (Differential Scanning Calorimetry) according to Standard ASTM D3418 (1999).

### II-BRIEF DESCRIPTION OF THE FIGURES

FIG. 1 is a diagram of the process for synthesizing the monofilament according to the invention before the latter is cut to a given length.

FIG. 2, which to facilitate understanding is not shown to scale, is a drawing showing a cross section of the monofilament according to the invention.

### III-DESCRIPTION OF THE INVENTION

The invention therefore relates to a monofilament (or fibre, the two terms can be used in an equivalent manner) made of polyester-resin composite (abbreviated to “PRC”) comprising polyester filaments embedded in a crosslinked resin (i.e. a resin cured after crosslinking), having a length within a range from 5 to 85 mm and a diameter ranging from 0.2 to 1.3 mm, and characterized in that the monofilament has a porosity of less than 2%.

“Polyester filaments” means filaments of linear macromolecules formed of groups held together by ester bonds. Polyesters are produced by polycondensation by esterification between a carboxylic diacid, or one of the derivatives thereof, and a diol. For example, polyethylene terephthalate can be manufactured by polycondensation of terephthalic acid and ethylene glycol. Among the known polyesters, mention may be made of polyethylene terephthalate (PET), polyethylene naphthalate (PEN), polybutylene terephthalate (PBT), polybutylene naphthalate (PBN), polypropylene terephthalate (PPT) or polypropylene naphthalate (PPN).

Preferably, the polyester filaments are filaments selected from polyethylene terephthalate (PET) and polyethylene naphthalate (PEN), preferably entirely made of polyethylene terephthalate (PET).

As an example of polyester fibres that can be used in the context of the present invention, mention may be made of the PET fibres marketed under the name “PET HMILS 334 TEX HSP40” by the company Hyosung, or under the name “1X50-3340-892-00” by the company Glanzstoff Longlaville.

Typically, the polyester filaments, preferably PET filaments, are present in the form of a single multifilament fibre or several multifilament fibres combined together. In the latter case, the multifilament fibres are preferably essentially unidirectional. Each of the multifilament fibres may comprise several tens, hundreds or even thousands of individual polyester, preferably PET, filaments. These very fine individual filaments generally, and preferably, have a mean diameter of from 15 to 35 μm, more preferentially from 15 to 25 μm. The cross section of the individual filaments is preferably cylindrical.

Preferentially, in the PRC monofilament of the invention, the filaments of the monofilament are essentially parallel to one another. In particular, the degree of alignment of the polyester filaments is preferably such that more than 85% (% by number) of the filaments have an inclination relative to the axis of the monofilament which is less than 2.0 degrees, more preferentially less than 1.5 degrees, this inclination (or misalignment) being measured as described in the above publication by Thompson et al. Also preferentially, the PRC monofilament according to the invention is not helically deformed, which is to say it is not twisted. In any event, the PRC monofilament has a number of turns per meter of less than 5, preferably less than 2, preferably less than 0.5, preferably from 0 to 0.5.

Preferably, the polyester fibres (i.e. filaments) weight content in the PRC monofilament is within a range from 20% to 60%, preferably from 25% to 40%.

This weight content of the polyester fibre is calculated using the ratio of the count of the initial polyester fibre to the count of the final PRC monofilament. The count (or linear density) is determined on at least three samples, each corresponding to a length of 50 m, by weighing this length; the count is given in tex (weight in grams of 1000 m of product—as a reminder, 0.111 tex is equal to 1 denier).

Furthermore, the volume fraction of polyester fibre in the PRC monofilament is advantageously within a range from 20% to 50%, preferably from 20% to 30%.

The volume fraction of polyester fibre in the final PRC monofilament corresponds to the surface fraction of polyester fibre of a cross section of the PRC monofilament relative to the total area of its cross section. The surface fraction of polyester fibre can be determined in the same way as described below for measuring the porosity.

Furthermore, the crosslinked resin represents from 40% to 80%, preferably from 60% to 75%, by weight, of the PRC monofilament of the invention. Furthermore, the volume fraction of resin in the PRC monofilament is advantageously within a range from 50% to 80%, preferably from 70% to 80%. The weight percentage and volume fraction of crosslinked resin can be obtained according to a method similar to the method for obtaining the weight content and volume fraction of the polyester fibre described above.

The resin used is, by definition, a crosslinkable (i.e. curable) resin which is capable of being crosslinked, cured by any known method, in particular and preferentially by UV (or UV-visible) radiation, preferably emitting in a spectrum ranging at least from 300 nm to 450 nm.

The term “resin” or “resin composition” is understood here to mean the resin in unmodified form or any composition based on this resin and comprising at least one additive (that is to say one or more additives) before crosslinking. The term “crosslinked” resin is of course intended to mean that the resin is cured (photocured and/or thermoset), in other words is in the form of a network of three-dimensional bonds, in a state specific to “thermosetting” polymers (as opposed to “thermoplastic” polymers).

Advantageously, the crosslinked resin is based on at least:
a crosslinkable resin selected from the group consisting of vinyl ester resins (preferably urethane vinyl ester resins), epoxy resins, polyester resins and mixtures thereof,
a crosslinking system preferably comprising a photoinitiator which is reactive to UV radiation above 300 nm.

As crosslinkable resin, use is preferably made of a polyester or vinyl ester resin, more preferentially a vinyl ester resin. A “polyester” resin is understood to mean, in a known way, a resin of unsaturated polyester type. As for vinyl ester resins, they are well known in the field of composite materials.

Without this definition being limiting, the vinyl ester resin is preferentially of epoxy vinyl ester type. Use is more preferably made of a vinyl ester resin, in particular of epoxide type, which, at least in part, is based on novolac (also known as phenoplast) and/or bisphenol (that is to say, grafted to a structure of this type), i.e. preferably a vinyl ester resin based on novolac, bisphenol, or novolac and bisphenol.

Preferably, the initial tensile modulus of the resin, measured at 23° C., is greater than 3.0 GPa, more preferably greater than 3.5 GPa.

An epoxy vinyl ester resin based on novolac (the part between the square brackets in formula I below) corresponds, for example, in a known manner, to formula (I) below:

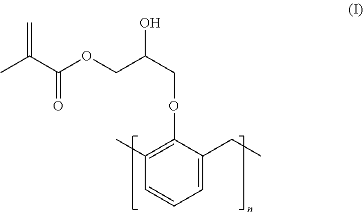

An epoxy vinyl ester resin based on bisphenol A (the part between the square brackets in formula (II) below) (the “A” serving as a reminder that the product is manufactured using acetone) corresponds, for example, to the formula:

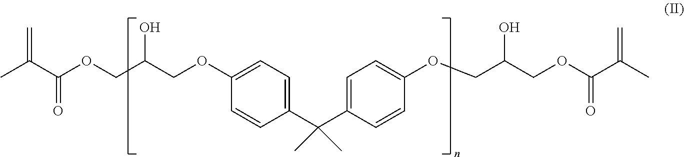

An epoxy vinyl ester resin of novolac and bisphenol type has shown excellent results. By way of example of such a resin, mention may notably be made of the vinyl ester resins “ATLAC 590” and “ATLAC E-Nova FW 2045” from the company AOC (diluted with approximately 40% styrene) described in the abovementioned patent applications EP-A-1 074 369 and EP-A-1 174 250. Epoxy vinyl ester resins are available from other manufacturers, for instance AOC (USA—“Vipel” resins).

The crosslinking system for the impregnation resin (resin composition) preferably comprises a photoinitiator which is sensitive (reactive) to UV radiation above 300 nm, preferably between 300 and 450 nm. This photoinitiator is used at a preferred content of 0.5% to 3%, more preferably of 1% to 2.5%. Preferably, the resin crosslinking system also comprises a crosslinking agent, for example at a content of between 5% and 15% (% by weight of impregnating composition), the crosslinking agent being as defined hereinabove.

Preferably, this photoinitiator is from the family of phosphine compounds, more preferentially a bis(acyl)phosphine oxide, such as, for example bis(2,4,6-trimethylbenzoyl)phenylphosphine oxide (“Omnirad 819” from IGM or “SpeedCure BPO” from Lambson), or a mono(acyl)phosphine oxide (for example “Esacure TPO” from IGM), it being possible for such phosphine compounds to be used as a mixture with other photoinitiators, for example photoinitiators of alpha-hydroxy ketone type, such as, for example, dimethylhydroxy acetophenone (e.g., “Omnirad 1173” from IGM) or 1-hydroxycyclohexyl phenyl ketone (e.g., “Omnirad 184” from IGM), benzophenones, such as 2,4,6-trimethylbenzophenone (e.g. “Esacure TZT” from IGM), and/or thioxanthone derivatives, such as, for example, isopropylthioxanthone (e.g. “Esacure Omnirad ITX” from IGM).

The crosslinking agent is preferably selected from the group consisting of the family of triacrylates.

The diameter D of the PRC monofilament of the invention is preferably within a range from 0.2 to 1.3 mm, preferably between 0.25 and 1.25 mm, more preferentially between 0.3 and 1.2 mm, in particular between 0.4 and 1.1 mm.

This definition covers both monofilaments of essentially cylindrical shape (with a circular cross section) and monofilaments of other shapes, for example oblong monofilaments (with a more or less flattened shape) or monofilaments with a rectangular cross section. In the case of a non-circular cross section and unless specifically indicated otherwise, by convention D is the diameter known as clearance diameter, that is to say the diameter of the imaginary cylinder of revolution that surrounds the monofilament, in other words the diameter of the circumscribed circle surrounding its cross section.

Furthermore, the length L of the PRC monofilament of the invention is preferably within a range from 10 to 80 mm, for example from 15 to 60 mm. In this case, the length/diameter ratio L/D of the PRC monofilaments of the invention is advantageously within a range from 10 to 110, preferably from 20 to 90, preferably from 25 to 80, preferably from 30 to 70.

According to the invention, the PRC monofilament advantageously has a porosity of less than 1%, preferably less than 0.5%. Advantageously, the porosity of the PRC monofilament is between 0% and 2%, preferably between 0.01% and 1%, preferably between 0.05% and 0.5%.

The porosity can be measured by microscopy, for example by scanning electron microscopy, preferably using area-calculation software, such as FIJI Program. To perform the measurement, the following protocol is preferably carried out:
a crosslinked PRC monofilament is procured,
it is coated with a cold coating resin, of epoxy type for example, for example in a vacuum coating device (CitoVac from the company Stuers for example),
the coated PRC monofilament is cut, for example using a hydraulic guillotine, such as “SH-5214” from the company Baileigh,
the cross section of the PRC monofilament is polished, for example using a mechanical polisher, from the company Mecapol for example, preferably to a final grain of 0.25 μm,
1 to 4 nm of gold is applied, for example using a gold sputter coater, such as a 108 or 208 series Cressington coater from the company Eloise,
the cross section of the PRC monofilament is observed with a (15 kV) scanning electron microscope, preferably under vacuum, and
using an image processing program, FIJI for example, the surface percentage of the porosity is calculated. The “porosity” of the PRC monofilament means any gas (in particular air) or void present within the PRC monofilament.

According to the invention, the PRC monofilament advantageously has a breaking stress Cr of greater than 300 MPa, more preferentially greater than or equal to 320 MPa. In particular, the monofilament has a breaking stress preferentially of between 300 and 500 MPa, preferably of 320 to 470 MPa.

Advantageously also, the PRC monofilament has an initial tensile modulus (denoted E₂₃), also called Young's Modulus, measured at 23° C., of greater than 4 GPa, preferably greater than 4.5 GPa. In particular, the monofilament preferentially has an E₂₃ of between 4 and 8 GPa, preferably between 4.5 and 7 GPa.

The mechanical tensile properties of the PRC monofilament (modulus E₂₃, breaking stress Cr and elongation at break Ar) may be measured in a known manner according to the protocol described in section IV-1 below.

The glass transition temperature, denoted Tg, of the crosslinked resin is preferably above 190° C., preferably above 195° C., in particular above 200° C. It is measured, in a known way, by DSC (Differential Scanning Calorimetry) in the second pass, for example, and unless specifically otherwise indicated in the present application, according to standard ASTM D3418 of 1999 (DSC apparatus “822-2” from Mettler Toledo; nitrogen atmosphere; samples first brought from ambient temperature (23° C.) to 250° C. (10° C./min), then rapidly cooled down to 23° C., before final recording of the DSC curve from 23° C. to 250° C., at a gradient of 10° C./min).

Preferably, the density (or mass per unit volume in g/cm³) of the PRC monofilament is between 1.15 and 1.25. It is measured (at 23° C.) by means of a specialized “PG503 DeltaRange” balance from the company Mettler Toledo; the samples, of a few cm, are successively weighed in air and immersed in ethanol, the software of the apparatus then determines the mean density over three measurements.

The invention also relates to a process for manufacturing monofilaments (or fibres, the two terms can be used in an equivalent manner) made of polyester-resin composite (abbreviated to “PRC”), comprising the following successive steps:
creating a rectilinear arrangement of polyester filaments and conveying this arrangement in a feed direction,
in a vacuum chamber, degassing the arrangement of polyester filaments by the action of the vacuum,
at the outlet of the vacuum chamber, after degassing, passing through an impregnation chamber under vacuum so as to impregnate said arrangement of polyester filaments with a photocurable resin composition, in the liquid state, referred to as the “impregnation resin”, so as to obtain a prepreg containing the polyester filaments and the resin composition,
passing said prepreg through a sizing die having a cross section of predefined area and shape, to give it the shape of a monofilament,
downstream of the die, in a UV irradiation chamber, polymerizing the resin composition under the action of UV rays, the irradiation chamber comprising a tube transparent to UV rays, referred to as an irradiation tube, through which the monofilament being formed travels, and through which a stream of inert gas passes, the run speed (denoted Vᵢᵣ) of the monofilament through the irradiation chamber being greater than 50 m/min, the irradiation time (denoted Dᵢᵣ) of the monofilament in the irradiation chamber being equal to or greater than 1.5 s, at the end of which step a PRC monofilament comprising polyester filaments embedded in a crosslinked resin is obtained,
cutting the monofilament to a length within a range from 5 to 85 mm, at the end of which step a PRC monofilament comprising polyester filaments embedded in a crosslinked resin according to the invention is obtained.

All the steps (arranging, degassing, impregnating, sizing, polymerizing, winding, where applicable, and cutting) of the process of the invention are, independently of one another, steps which are known to those skilled in the art, as are the materials (multifilament fibres and resin compositions) used; they have been described, for example, in either or both of the patent applications EP-A-1 074 369 and EP-A-1 174 250.

According to the invention, it will be recalled notably that before any impregnation of the fibres, an essential step of degassing the arrangement of fibres by the action of the vacuum must be carried out, in order notably to boost the effectiveness of the subsequent impregnation, and above all to guarantee the absence of bubbles within the final composite monofilament.

After passing through the vacuum chamber, the polyester filaments enter an impregnation chamber which is completely full of impregnation resin and thus devoid of air: it is in this sense that this impregnation step can be termed “impregnation under vacuum”.

The die referred to as the “sizing” die makes it possible, by having a cross section of given dimensions, generally and preferably circular or rectangular, to adjust the proportion of resin with respect to the polyester fibres, preferably PET fibres, while at the same time giving the prepreg the shape and thickness required for the monofilament.

Advantageously, the monofilament leaving the sizing die has a diameter ranging from 0.2 to 1.3 mm, preferably from 0.25 to 1.25 mm, preferably from 0.3 to 1.2 mm.

The polymerization or UV irradiation chamber subsequently has the role of polymerizing or crosslinking the resin under the action of the UV radiation.

The UV irradiation chamber comprises one or more UV irradiators (or radiators). Advantageously, the irradiation chamber comprises a plurality of UV irradiators, that is to say at least two (two or more than two) which are arranged in a row around the irradiation tube. Each UV irradiator typically comprises one (at least one) UV lamp (preferably emitting in a spectrum from 200 to 600 nm) and a parabolic reflector at the focal point of which is the centre of the irradiation tube; it delivers a linear power density preferably of between 2000 and 14 000 watts per meter. More preferably still, the irradiation chamber comprises at least three, in particular at least four UV irradiators in a row.

Even more preferably, the linear power density delivered by each UV irradiator is between 2500 and 12 000 watts per meter, in particular in a range from 3000 to 10 000 watts per meter.

UV radiators which are suitable for the process of the invention are well known to those skilled in the art, for example those sold by the company Dr. Hönle AG (Germany) under the reference “1055 LCP AM UK”, fitted with “UVAPRINT” lamps (iron-doped high pressure mercury lamps). The nominal (maximum) power of each radiator of this type is equal to approximately 13 000 watts, the power output actually being able to be regulated with a potentiometer between 30% and 100% of the nominal power.

The diameter of the irradiation tube (preferably made of glass) is preferably between 10 and 80 mm, more preferably between 20 and 60 mm.

Between the sizing die and the final receiving support, it is preferred to keep the tensions to which the polyester fibres are subjected at a moderate level, preferably between 0.2 and 2.0 cN/tex, more preferably between 0.3 and 1.5 cN/tex; in order to control this, it will be possible for example to measure these tensions directly at the outlet of the irradiation chamber, by means of suitable tension meters well known to those skilled in the art.

The final PRC monofilament thus formed through the UV irradiation chamber, and in which the resin is now in the solid state, is then recovered for example on a take-up reel, on which a very great length of it may be wound. The process may thus comprise a winding step for storing the monofilament after it has passed through the UV irradiation chamber.

The monofilament may be cut so as to obtain monofilaments with a length in a range from 5 to 85 mm, preferably from 10 to 80 mm, preferably from 15 to 60 mm. In this case, the monofilaments advantageously have a length/diameter ratio ranging from 10 to 110, preferably from 20 to 90, preferably from 25 to 80, preferably from 30 to 70.

Particularly advantageously, the process for manufacturing the PRC monofilament of the invention comprises the following essential steps:
the run speed (Vᵢᵣ) of the monofilament through the irradiation chamber is greater than 50 m/min;
the run time (Dᵢᵣ) of the monofilament through the irradiation chamber is equal to or greater than 1.5 s and equal to or less than 10 s;
the irradiation chamber comprises a tube which is transparent to UV rays (such as a quartz tube or preferably a glass tube), referred to as an irradiation tube, through which the monofilament moves during formation, this tube having a stream of inert gas flowing through it, preferably nitrogen.

These combined steps make it possible to achieve the preferred improved properties of the PRC monofilament of the invention, namely, in particular, the improved Tg, elongation Ar and modulus (E and E′) properties.

In particular, in the absence of flushing with an inert gas such as nitrogen in the irradiation tube, it has been observed that the above properties of the PRC monofilament deteriorated quite quickly during manufacture and thus that industrial performance was no longer guaranteed.

Moreover, if the irradiation time Dᵢᵣ of the monofilament in the irradiation chamber is too short (less than 1.5 s), numerous tests have shown that the resin is not sufficiently crosslinked, which leads to a deterioration of the mechanical properties, including the breaking stress and the flexural strength. Moreover, if the irradiation time Dᵢᵣ of the monofilament in the irradiation chamber is too long (more than 10 s for example), this increases the risk of boiling the resin and therefore creating more porosity and impairing the mechanical properties, including the breaking stress.

Thus, it is understood that it is thanks to the combination of the steps of the process according to the invention, in particular thanks to the steps of degassing the arrangement of polyester filaments through the action of the vacuum, in the vacuum chamber, and of polymerization in the irradiation tube through which a stream of inert gas passes, at the abovementioned speed Vᵢᵣ and for the abovementioned irradiation time Dᵢᵣ, that PRC monofilaments having a porosity of less than 2% and a breaking stress of greater than 300 MPa are obtained.

It was also observed that a high speed of irradiation Vᵢᵣ (greater than 50 m/min, preferably between 50 and 150 m/min) was favourable, on the one hand, for an excellent degree of alignment of the polyester filaments within the PRC monofilament, and, on the other hand, for a better retention of the vacuum inside the vacuum chamber, with a significantly reduced risk of having a certain fraction of the impregnation resin moving back from the impregnation chamber toward the vacuum chamber, and therefore for a better impregnation quality.

Preferably, the speed Vᵢᵣ is between 50 and 150 m/min, more preferably in a range from 60 to 120 m/min.

Preferably, the irradiation time Dᵢᵣ is between 1.5 and 10 s, more preferentially in a range from 2 to 5 s.

One subject described herein is a PRC monofilament capable of being obtained by a process according to the invention, preferably according to which:
the run speed (Vᵢᵣ) of the monofilament through the irradiation chamber is greater than 50 m/min;
the run time (Dᵢᵣ) of the monofilament through the irradiation chamber is equal to or greater than 1.5 s and equal to or less than 10 s;
the irradiation chamber comprises a tube which is transparent to UV rays (such as a quartz tube or preferably a glass tube), referred to as an irradiation tube, through which the monofilament moves during formation, this tube having a stream of inert gas flowing through it, preferably nitrogen,
the PRC monofilament has a length ranging from 5 to 85 mm, preferably from 10 to 80 mm, preferably from 15 to 60 mm,
the PRC monofilament has a diameter ranging from 0.2 to 1.3 mm, preferably from 0.25 to 1.25 mm, preferably from 0.3 to 1.2 mm

The PRC monofilament capable of being obtained by a process according to the invention therefore comprises polyester filaments, preferably PET filaments, impregnated in a crosslinked resin, has a length ranging from 5 to 85 mm, a diameter ranging from 0.2 to 1.3 mm, and a porosity of less than 2%. All of the features described above for the monofilament according to the invention also apply to the monofilament capable of being obtained by the process according to the invention. In particular, taking into account the specific steps of the process according to the invention, the monofilament advantageously has a porosity of less than 1%, preferably less than 0.5%, and/or a breaking stress of greater than 300 MPa, preferably greater than or equal to 320 MPa and/or an initial tensile modulus denoted E₂₃ of the monofilament, measured at 23° C., greater than 4 GPa, preferably greater than 4.5 GPa.

The invention also relates to a bundle comprising a plurality of PRC monofilaments according to the invention (or capable of being obtained by the process according to the invention) and at least one element for holding the cut monofilaments together. Preferably, this holding element is a breakable film, for example a tearable, dispersible, water-soluble film. Preferably, the at least one holding element is a water-soluble thread.

Advantageously, the holding element is a water-soluble film, preferably made of a material selected from the group consisting of polyvinyl alcohols (PVA) or any water-soluble or bioplastic polymer, such as bioplastics derived from milk casein. Preferably, the at least one water-soluble film is made of a material selected from the group consisting of polyvinyl alcohols.

The bundle according to the invention advantageously comprises a number of cut monofilaments within a range from 300 to 20 000.

The monofilaments that make up the bundle can be of identical or different dimensions. For example, a bundle can comprise monofilaments of different lengths, diameters and/or length-to-diameter ratios. Advantageously, the bundle comprises monofilaments according to the invention having lengths and diameters not differing from one another by more than 10%, preferably more than 3%.

As stated above, the monofilaments according to the invention are particularly useful as an additive for concrete. Thus, the invention also relates to the use of at least one PRC monofilament according to the invention (or capable of being obtained by the process according to the invention) or of a bundle according to the invention, to reinforce concrete and/or reduce the weight of concrete and/or reduce or prevent cracking of concrete.

The invention also relates to a concrete comprising a plurality of cut PRC monofilaments according to the invention (or capable of being obtained by the process according to the invention). The concrete may be prepared by any technique well known to a person skilled in the art.

Advantageously, the volume ratio of the monofilaments according to the invention in the concrete according to the invention is within a range from 0.1% to 6%, for example from 0.1% to 1.5% for “conventional” concretes, for example of BPS C40/50 XA3 type, or from 1.5% to 6% for ultra-high performance fibre-reinforced concretes (UHPFRC).

Examples of the manufacture of PRC monofilaments according to the invention and the use thereof for reinforcing a concrete are described below.

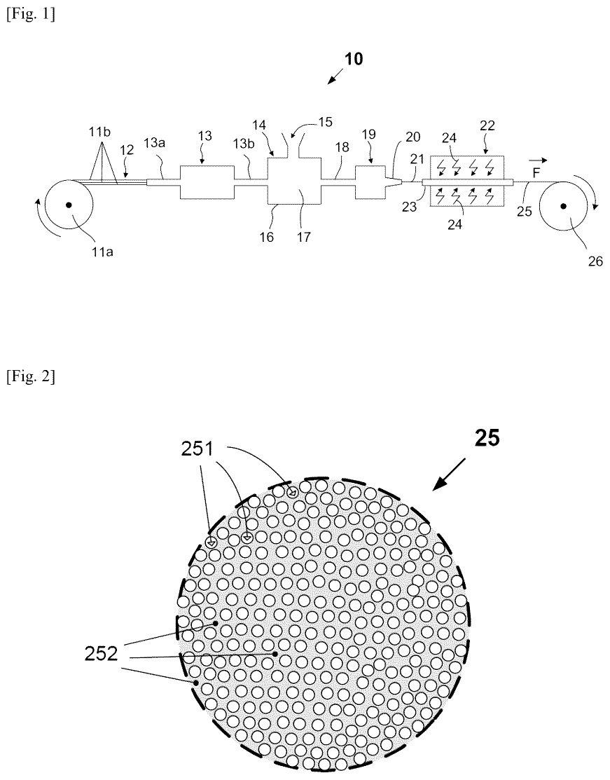

Appended FIG. 1 schematically illustrates, in a very simple manner, an example of a device which makes possible the production of PRC monofilaments in accordance with the invention.

This figure shows a reel 11a containing, in the example illustrated, polyester fibres 11b (in the form of multifilaments). The reel is unwound continuously by driving, so as to produce a rectilinear arrangement 12 of these fibres 11b. In general, the reinforcing fibres are delivered in “rovings”, that is to say already in groups of fibres wound in parallel onto a reel; for example, use is made of polyester fibres sold by Glanzstoff Longlaville under the name “1X50-3340-892-00”, with a count equal to 334 tex (as a reminder, 1 tex=1 g/1000 m of fibre). It is, for example, the traction exerted by the rotating receiver 26 which will enable the fibres to advance in parallel and enable the PRC monofilament to advance along the entire length of the facility 1.

This arrangement 12 then passes through a vacuum chamber 13 (connected to a vacuum pump, not shown), arranged between an inlet tubing 13a and an outlet tubing 13b which opens into an impregnation chamber 14, the two tubings preferably with rigid walls having, for example, a minimum cross section greater than (typically twice as large as) the total cross section of the fibres and a length very much greater (typically 50 times greater) than said minimum cross section.

As already taught by the aforementioned patent application EP-A-1 174 250, the use of tubings with rigid walls both for the inlet opening into the vacuum chamber and for the outlet opening of the vacuum chamber and the transfer from the vacuum chamber to the impregnation chamber proves to be compatible at the same time with high rates of passage of the fibres through the openings without the fibres breaking, and also makes it possible to ensure sufficient sealing. All that is required, if need be experimentally, is to find the largest flow cross section, given the total cross section of the fibres to be treated, that will still allow sufficient sealing to be achieved, given the rate of advance of the fibres and the length of the tubings. Typically, the vacuum inside the chamber 13 is, for example, of the order of 0.1 bar, and the length of the vacuum chamber is approximately 1 meter.

On exiting the vacuum chamber 13 and the outlet tubing 13b, the arrangement 12 of fibres 11b passes through an impregnation chamber 14 comprising a feed tank 15 (connected to a metering pump, not depicted) and a sealed impregnation tank 16 completely full of impregnating composition 17 based on a curable resin of vinyl ester type (e.g. “ALTAC® E-Nova FW 2045” from AOC). By way of example, the composition 17 also includes (in a weight content of 1% to 2%) a photoinitiator suitable for UV and/or UV-visible radiation and with which the composition will subsequently be treated, for example bis(2,4,6-trimethylbenzoyl)phenylphosphine oxide (“Omnirad 819” from the company IGM). It may also include (for example approximately 5% to 15% of) a crosslinking agent, for instance tris(2-hydroxyethyl)isocyanurate triacrylate (“SR 368” from the company Sartomer). Needless to say, the impregnation composition 17 is in the liquid state.

Preferentially, the impregnation chamber is several meters long, for example between 2 and 10 m, in particular between 3 and 5 m.

Thus, a prepreg which comprises for example (in % by weight) from 65% to 75% solid fibres 11b, the remainder (25% to 35%) being formed of the liquid impregnating matrix 17, leaves the impregnation chamber 14, in a sealed outlet tubing 18 (still under rough vacuum).

The prepreg then passes through sizing means 19 including at least one sizing die 20, of which the passage (not shown here), for example of circular, rectangular or even conical shape, is suited to the specific implementation conditions. By way of example, this passage has a minimum cross section of circular shape, the downstream orifice of which has a diameter slightly greater than that of the target monofilament. Said die has a length which is typically at least 100 times greater than the minimum dimension of the minimum cross section. Its purpose is to give the finished product good dimensional precision, and it may also serve to meter the content of fibre with respect to resin. According to one possible implementation variant, the die 20 can be directly incorporated into the impregnation chamber 14, thereby avoiding, for example, the need to use the outlet tubing 18.

Preferentially, the sizing zone is several centimeters long, for example between 5 and 50 cm, in particular between 5 and 20 cm long.

By virtue of the sizing means (19, 20) a “liquid” composite monofilament 21 (liquid in the sense that its impregnation resin is still liquid) is obtained, the shape of the cross section of which is preferably essentially circular.

At the outlet of the sizing means (19, 20), the liquid composite monofilament 21 obtained in this way is then polymerized by passing through a UV irradiation chamber (22) comprising a sealed glass tube (23) through which the composite monofilament travels; said tube, the diameter of which is typically a few centimeters (for example 2 to 3 cm), is irradiated by a plurality of (here, for example, four) UV irradiators (24) in a row (“UVAprint” lamps from Dr. Hönle, with a wavelength of 200 to 600 nm) arranged a short distance (a few centimeters) away from the glass tube.

Preferably, the irradiation chamber is several meters long, for example between 2 and 15 m, in particular between 3 and 10 m long.

The irradiation tube (23) in this example has a stream of nitrogen flowing through it.

The irradiation conditions are preferably adjusted such that, in the irradiation chamber, the temperature of the PRC monofilament, measured at the surface thereof (for example by means of a thermocouple) is greater than the Tg of the crosslinked resin (in other words above 190° C.) and more preferably below 270° C.

Once the resin has polymerized (cured), the PRC monofilament (25), which is now in the solid state and entrained in the direction of the arrow F, then arrives at the final take-up reel thereof (26).

Finally, a finished, manufactured composite entity is obtained, as depicted very simply in FIG. 2, in the form of a continuous, very long PRC monofilament (25), the individual polyester filaments (251) of which are distributed uniformly throughout the volume of cured resin (252). The diameter thereof is, for example, equal to approximately 0.5 mm.

By virtue of the operating conditions described above, the process of the invention may be carried out at high speed, greater than 50 m/min, preferably between 50 and 150 m/min, more preferably in a range from 60 to 120 m/min.

The continuous PRC monofilament (25) can be chopped to a given length (not shown in FIG. 1), for example 45 mm, by any means known to those skilled in the art, for example using a hydraulic guillotine, such as “SH-5214” from Baileigh. This step can be carried out directly at the exit from the irradiation chamber (23). It can also be carried out after the monofilament has been packaged on a final take-up reel (26). In that case, it is preferable to unwind the monofilament from the reel from that end of the monofilament that is axially furthest toward the outside of the reel, in order to avoid helically deforming the monofilament. To be specific, if the monofilament is unwound from the reel from that end of the monofilament that is axially furthest toward the inside of the reel, this helically deforms the monofilament, which can be detrimental for the breaking stress.

### IV-EXAMPLES

### IV-1 Measurements and Tests Used

The porosity was measured according to the protocol:
a crosslinked PRC monofilament was procured,
it was coated with a cold coating resin, of epoxy type, in a vacuum coating device (CitoVac from the company Stuers),
the PRC monofilament coated with adhesive was cut using a hydraulic guillotine (SH-5214 from the company Baileigh),
the cross section of the PRC monofilament was polished using a mechanical polisher, from the company Mecapol, to a final grain of 0.25 μm,
1 to 4 nm of gold was applied using a gold sputter coater (a 108 or 208 series Cressington coater from the company Eloïse),
the cross section of the PRC monofilament was observed with a (15 kV) scanning electron microscope under vacuum, and
using an image processing program, FIJI for example, the surface percentage of the porosity was calculated (% porosity=area of porosity/(area of porosity+area of the fibres+area of the crosslinked resin).

The tensile mechanical properties of the PRC monofilament (modulus E₂₃, breaking stress Cr and elongation at break Ar) were measured using an “INSTRON” type 5944 tensile testing machine (BLUEHILL® UNIVERSAL software supplied with the tensile testing machine), according to standard ASTM D2343, at a temperature of 23° C., on adhesive-coated (i.e. ready to use) PRC monofilaments. Before measurement, these monofilaments were subjected to prior conditioning (storage of the monofilaments for at least 24 hours in a standard atmosphere in accordance with European standard DIN EN 20139 (temperature of 23±2° C.; relative humidity of 50±5%)). To prevent damage to the polyester reinforcements when gripping the sample in the jaws of the tensile test machine, end-pieces (Material: Cardboard 50 mm long; Adhesive used: Loctite EA 9483 (two-part epoxy)) were attached as follows. The surfaces of the two facing end-pieces were coated with adhesive, as was the reinforcement in order to limit as far as possible any “dry zones” (zones without adhesive). The end-pieces were held in place for the curing time (12 h at 23° C.) in a jig with the dimensions of the test specimens, with weights on the end-pieces to ensure good end-piece/reinforcement contact. The tensile modulus was determined by linear regression of the curve of stress as a function of strain, between 0.1% and 0.6% strain. This strain was recorded by the extensometer MultiXtens 1995DA801. The 260 mm specimens tested underwent traction at a nominal speed of 5 m/min, under a pre-test preload of 0.5 MPa (reference length 50 mm, distance between the jaws: 150 mm). All the results given are an average over 5 measurements.

### IV-2 Tests on Monofilaments

PRC monofilaments (M1 and M2) were manufactured according to the process described above with a run speed Vᵢᵣ of the monofilaments in the irradiation chamber of 100 m/min, an irradiation time Dᵢᵣ of the monofilament in the irradiation chamber of 2.4 s, the length of the irradiation chamber being 4 m. The resin composition used was based on vinyl ester resin (“ATLAC E-NOVA FW2045” from the company), a triacrylate hardener (“SR 368” from the company Sartomer) and a photoinitiator (“Omnirad 819” from the company IGM). The polyester filaments of the monofilaments M1 and M2 were respectively “1X50-3340-892-00” filaments from Glanzstoff Longlaville. The diameter and the tex of the monofilaments as well as their physical characteristics and mechanical properties are presented in Table 1 below.

TABLE 1

| | M1 | M2 |
|---|---|---|
| Diameter (mm) | 1.01 | 1.19 |
| Polyester fibre tex (g/km) | 334 | 668 (2 × 334) |
| Polyester fibre/resin weight ratio | 25/75 | 49/51 |
| Porosity (%) | 0.9 | 1.4 |
| Breaking stress (MPa) | 322 | 471 |
| Young's modulus (GPa) | 5.0 | 6.3 |

The porosity and the breaking stress of these monofilaments were compared with reinforcing fibres for concrete of the prior art. It was observed that these fibres of the prior art systematically have a degree of porosity of greater than 2% and a breaking stress less than or equal to 300 MPa.

Because of their low degree of porosity and their high breaking stress, the monofilaments of the invention make it possible to improve the resistance to cracking of the concrete.

It has thus been found that the monofilaments in accordance with the invention offer an improved compromise in performance between, in particular, mechanical strength, corrosion resistance, processability (in particular the dispersibility during mixing, the processing temperature and the maintenance of uniformity during the drying of the concrete).

1.-15. (canceled)

16. A polyester-resin composite monofilament comprising polyester filaments embedded in a crosslinked resin, having a length within a range from 5 to 85 mm and a diameter ranging from 0.2 to 1.3 mm,
wherein the monofilament has a porosity of less than 2%.

17. The monofilament according to claim 16, wherein the length is within a range from 10 to 80 mm and the diameter is within a range from 0.25 to 1.25 mm.

18. The monofilament according to claim 16, wherein a length/diameter ratio ranges from 10 to 110.

19. The monofilament according to claim 16, wherein the polyester filaments represent from 20% to 60% by weight of the monofilament, and the crosslinked resin represents from 40% to 80% by weight of the monofilament.

20. The monofilament according to claim 16, wherein the polyester filaments each have a mean diameter within a range from 15 to 35 μm.

21. The monofilament according to claim 16, wherein the crosslinked resin is based on at least:
a crosslinkable resin selected from the group consisting of vinyl ester resins, epoxy resins, polyester resins and mixtures thereof; and
a crosslinking system comprising a photoinitiator which is reactive to UV radiation above 300 nm.

22. The monofilament according to claim 16, wherein the polyester filaments are filaments selected from the group consisting of polyethylene terephthalate and polyethylene naphthalate.

23. The monofilament according to claim 16, wherein the porosity is less than 1%.

24. The monofilament according to claim 16, wherein the monofilament has a breaking stress greater than 300 MPa.

25. The monofilament according to claim 16, wherein an initial tensile modulus, denoted E23, of the monofilament, measured at 23° C., is greater than 4 GPa.

26. A concrete comprising a plurality of monofilaments according to claim 16.

27. The concrete according to claim 26, wherein a volume ratio of the monofilaments in the concrete is within a range from 0.10% to 6%.

28. A process for manufacturing the monofilament according to claim 16, the process comprising the following successive steps:
creating a rectilinear arrangement of the polyester filaments and conveying the rectilinear arrangement in a feed direction;
in a vacuum chamber, degassing the rectilinear arrangement of polyester filaments through vacuum;
at an outlet of the vacuum chamber, after degassing, passing through a vacuum impregnation chamber so as to impregnate the rectilinear arrangement of polyester filaments with a photocurable resin composition in a liquid state so as to obtain a prepreg containing the polyester filaments and the resin composition;
passing the prepreg through a sizing die having a cross-section of predefined area and shape, to give the prepreg a shape of a monofilament;
downstream of the sizing die, in a UV irradiation chamber, polymerizing the resin composition under UV rays, the irradiation chamber comprising an irradiation tube transparent to UV rays through which the monofilament being formed travels, and through which a stream of inert gas passes, a run speed Vir of the monofilament through the irradiation chamber being greater than 50 m/min, and an irradiation time Dir of the monofilament in the irradiation chamber being equal to or greater than 1.5 s; and
cutting the monofilament to a length within a range from 5 to 85 mm.

29. The process according to claim 28, wherein the monofilament has a diameter ranging from 0.3 to 1.2 mm.

30. The process according to claim 28, wherein the polyester filaments are filaments selected from the group consisting of polyethylene terephthalate and polyethylene naphthalate.
